(19) United States
(12) Patent Application Publication
(10) Pub. No.: US 2006/0152090 A1
(43) Pub. Date: Jul. 13, 2006

(54) Device for waking up a control unit

(75) Inventors: Walter Hubert, Darmstadt (DE); Gerhard Nagel, Gaertringen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/536,786

(22) PCT Filed: Oct. 21, 2003
(86) PCT No.: PCT/EP03/11616

§ 371 Date: Oct. 21, 2005

(30) Foreign Application Priority Data
Nov. 28, 2002 (DE) 10255449.8

(51) Int. Cl. H01H 47/00

(52) U.S. Cl. 307/140

(57) ABSTRACT

A system for prompting a control unit in a transport device has a power supply circuit for changing the control unit from a normal operational state to a sleep mode. A prompting device is operable to switch the power supply through in order to change the control unit into the normal operational state. The prompting device is not supplied with current in the sleep modes and has a dischargeable energy accumulator. When the prompting device is operated, the energy of the energy accumulator is used to change the control unit into the normal operational states; as a result of the energy of the energy accumulator a switch is operable to connect the control unit to the power supply.

### BACKGROUND AND SUMMARY OF THE INVENTION

This application claims the priority of German patent application 102 55 449.8, filed Nov. 28, 2002 (PCT International Application PCT/EP2003/011616, filed Oct. 21, 2003), the disclosure of which is expressly incorporated by reference herein.

The invention relates to a system for prompting a control unit in a vehicle having a power circuit for the control unit, in order to change the control unit from a normal operational state to a sleep mode, and having a prompting device which is operable to switch the power supply into the normal operational state.

In transport devices, particularly motor vehicles and airplanes, the many individual control units are interconnected by data bus systems. To reduce the power consumption, the data bus and the control units can be changed, partially or completely, to certain modes in which control units operate at a full power consumption in the normal operational state, or in a sleep state in which the power consumption is reduced.

In vehicles, such interconnected systems (for example, a so-called CAN bus according to ISO 11519 or ISO 11898) are used to control engine functions or comfort functions in the vehicle interior. In recent years, these data bus systems have become increasingly specialized, with additional data buses being used for brake-by-wire systems or for telecommunication, such as D2B or MOST data buses. As a result of the high degree of interconnection, the problem now arises that the onboard power supply itself is loaded even when the vehicle is switched off, and no control function, or only a few, are actually required. In order to reduce the power consumption in the sleep mode, the control units are switched off after a defined time, in which case it is necessary that the system can, for example, receive a signal from a transponder for the unlocking of a door or the like. For this purpose, it must be possible to prompt the individual control units out of the sleep mode by means of the transponder or other operating switches or signals.

German Patent Document DE 197 15 880 C1 discloses a system having data-bus-interconnected control units. An individual control unit is provided as a master control unit and is equipped with a standby operating function with a prompting capability and is continuously active. In the inoperative state of the motor vehicle, the master control unit is in a standby state while the other control units are switched off. When the master control unit receives a prompt signal, it prompts the other control units by way of a control line, so that these control units are again supplied with current and can operate in their normal function.

German Patent Document DE 196 11 945 C1 reveals a system whose control units remain in an operational mode from which they can very rapidly be changed back into a normal operational state. For this purpose, a semiconductor device is switched in front of each control unit and in front of its bus protocol module, which semiconductor device can be supplied from a higher-ranking voltage potential and can be prompted from a sleep mode by means of a control input. The prompting operation takes place by way of a control signal as a result of which causes the above-mentioned semiconductor device to switch through the power supply.

In these known systems, at least one control unit must always remain switched-on so that it can then prompt the remaining control units, when necessary. In a sleep mode in which also the voltage regulator of the last control unit is also switched off, the control units can no longer be prompted, because the switches for the prompting or the logic circuits, which are required for connecting the operating voltage for the control unit, are not supplied with current and are therefore also not operable. The reason is that a currentless operating switch cannot connect the power supply for the control unit. For example, during prompting by a transponder, a logic circuit must also be supplied with current. However, in the sleep mode, the current is not present because the power supply is switched off and the switches or existing logic circuits are also supplied by way of the operating voltage of the respective control unit.

U.S. Pat. No. 5,767,844 shows a computer with a switch mounted on the keyboard for switching the computer on. Its switch-on pulse is transmitted by way of a USB cable for supplying power to the computer in order to switch on the computer. For providing the switch-on power, the switch is buffered by a separate battery. In the case of a passenger car, however, this construction would require that a charged buffer battery be constantly present, which would have to be replaced repeatedly over the service life of the vehicle.

One object of the present invention is to provide a system for prompting a control unit, in which individual control units can be changed from a sleep mode, and in which the power supply of the control units is switched off, back into the normal operational state, without requiring that a master control unit remain operative to provide electric power for the prompting operation.

This and other objects and advantages are achieved by the system according to the invention, in which no current is supplied to the prompting device in the sleep mode, and a dischargeable energy accumulator is provided. When the prompting device is operated, the power of the energy accumulator can be used to change the control unit into the normal operational state, and a switch which connects the control unit to a power supply line is operable by means of the power of the energy accumulator. The energy accumulator (5, 8) can be charged in the normal operational state, or the mechanical energy can be converted to electric power when the prompting device (2) is operated.

In the system according to the invention, a prompting device is provided which has at least one operating element, such as an operating switch, a remote control or an access chip card. In addition, the prompting device can also provide a logic circuit which checks, for example, the access authorization by means of a security code, or the like. According to the invention, the prompting device has its own energy accumulator from which the power originates for the prompting operation and for logic checking of the prompting request. As a result, the control unit assigned to the prompting device can be switched off because it does not have to remain operative for supplying power for the prompting device.

In a preferred further development of the invention, a voltage regulator is arranged between the vehicle battery and the control unit. The voltage regulator can also be switched off by the switch when the traffic device (and thus the control unit) are in the inoperative state. This is a considerable advantage because the service life of the voltage regulator is increased and the current consumption of the control unit is considerably reduced. In the normal operational state, the voltage regulator supplies the control unit with an operating voltage Vcc of, for example, 5 volts, and is switched off in the inoperative state. The prompting device then closes, for example, during its operation, an electric switch, particularly a transistor or a relay. The switch then connects the control unit or the voltage regulator with the electric supply voltage U Bat of the battery of the transport device.

The energy accumulator of the prompting device is charged when, during operation of the prompting device, a mechanical operating force is converted to electric power. A piezogenerator can be used for this purpose, or an energy generating device of the type in which a metal body or wire is moved through a magnetic field, generating an induced voltage. As a result, the energy accumulator of the prompting device provides the electric power which is required for closing a switch in order to prompt the assigned control unit. In addition (or as an alternative) to the energy accumulator, an auxiliary energy accumulator can be charged in the normal operational state.

If a piezogenerator is provided in the prompting device, the latter can be coupled with a mechanical energy accumulator which then permits an energy conversion to electric power in order to operate a switch for prompting the control unit. By operating the operating switch of the prompting device, the piezogenerator generates electric power which charges the energy accumulator of the prompting device. If the energy stored in the energy accumulator exceeds a threshold value, it is supplied to a logic circuit assigned to the prompting device. The logic circuit then checks possibly defined switch-on conditions for the control unit and, if the result is positive, switches through the power supply of the traffic device (that is, the vehicle battery for the corresponding control unit) so that the latter can run up to the normal operational mode.

An electronic key for the access authorization to the motor vehicle does not require its own battery because, during the operation, the transmitting energy originates from the energy accumulator of the electronic key. Inside the motor vehicle, the electronic key can then be supplied with energy by way of electromagnetic coupling, so that the energy accumulator provided as the accumulator can be additionally charged.

One advantage of the invention lies in the fact that the prompting device, previously continuously supplied with current at the onboard power supply, can be operated in the sleep mode independently of the onboard power supply. As a result, also an assigned control unit as a whole can be changed to a currentless state, because the prompting device does not have to be supplied with current by the control unit. As a result of the present invention, the energy balance in the onboard power supply can be considerably improved in the sleep state of the data bus system. Components previously operated by the battery of the transport device can be provided without such a power supply.

Other objects, advantages and novel features of the present invention will become apparent from the following detailed description of the invention when considered in conjunction with the accompanying drawings.

### BRIEF DESCRIPTION OF THE DRAWINGS

FIGS. 1 and 2 show respective circuit diagrams for an electronic embodiment of the system according to the invention having a prompting device, an energy accumulator and the assigned control unit.

### DETAILED DESCRIPTION OF THE DRAWINGS

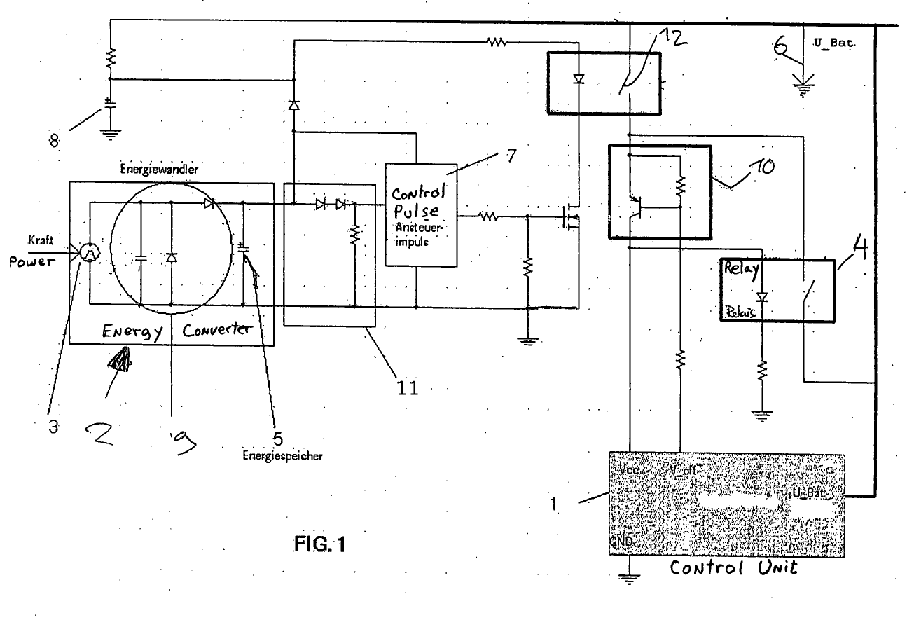

Referring to FIG. 1, the system for prompting the control unit 1 includes a prompting device 2. When an operating element 3 is operated, the prompting device 2 switches the power supply for the control unit 1, via an electronic switch 11, for example, an electronic relay 4. By means of the switch 10, the control unit 1 can be changed to a sleep mode by a switch-off signal V off generated by the software of the control unit 1, by interrupting the connection between the control unit 1 and the battery voltage U Bat.

The system can be used in a data bus system, where many control units are mutually interconnected. During the operation of the vehicle, particularly during driving, the control units 1 are in a normal operational state, in which each control unit 1 is supplied by the battery voltage U BAT. The operating voltages Vcc of, for example, 5 V, required inside the control unit 1 are generated by assigned voltage regulators which are fed by the battery voltage U Bat. At the control unit 1, all internal voltage regulators can be switched off in the sleep mode. Thus, there is no need for the finite quiescent current which is required for detecting a function demand according to the state of the art. The advantage of the implementation introduced in the application is that, in the sleep mode, the control unit 1 is virtually in a currentless state or, if required, consumes only an extremely low leakage current (<1 μA).

The prompting device 2 is provided in order to switch the assigned control unit 1 from the sleep mode back into the normal operational state. In the sleep mode, the prompting device 2 is not supplied with current. The electric power generated during the operation of the operating switch 3 of the prompting device 2 is charged into an energy accumulator 5; and if required, a portion of it is also charged into an auxiliary energy accumulator 8. The auxiliary energy accumulator 8 is maintained in a charged condition from the battery 6 by way of a resistor. The energy of the energy accumulators 5 and 8 is used for generating for a few milliseconds the supply voltage for a pulse generator stage 7 (for example, in the CMOS technique) as well as the input signal for the pulse stage 7 by means of an input wiring 11 such that a reliable switching operation is caused.

For generating the prompting power, a so-called piezoelectric generator (abbreviated piezogenerator) 9 can be used: the mechanical operating energy at the operating element 3 generates an electric power which charges the energy accumulator 5. The energy can then be used for the switching of the electric switches 4, 12, and additionally the electric power can permit reliability checks and diagnostic functions. A rectifier 14 can, in each case, be connected in front of the energy accumulator 5, which permits the utilization of both polarities of the alternating voltage generated by the piezogenerator 9. Furthermore, the auxiliary energy accumulator 8 can supply a supplementary energy which supplements the energy made available from the energy accumulator 5 during the switch-on operation.

The output of the control pulse stage 7 provides a switching signal of a defined time length (for example, 1 ms), which first switches on the semiconductor relay 12. For this purpsoe, a defined current is required which is supplied from the energy accumulator 5 and/or from the auxiliary energy accumulator 8. When an auxiliary energy accumulator 8 is present, the technical expenditures in the case of the prompting device 2 can be reduced because the energy accumulator may have smaller dimensions. The leakage current resulting from the auxiliary energy accumulator 8 is very low. By means of suitable backup capacitors (for example, foil capacitors), the leakage current can be limited to values of below 10 nA.

The brief switching operation triggered in the relay 12 leads to the immediate switching on of the relay 4 which remains in a locking switching. The switch 10 is normally connected unless it receives a blocking signal V off from the control unit 1. The switching-on of the relay 4 results in a switching of the battery voltage U Bat onto the input of the semiconductor relay 12, so that the battery voltage 6 is switched through to the control unit 1. The switched current supply path for the control unit 1 is capable of meeting the current requirement needed by the control unit 1 in normal operation. The power supply of the control unit 1 is interrupted by the switch-off signal V off when the control unit 1 switches over to the sleep mode.

An unintentional switching-on of the control unit 1 by electromagnetic interference fields is virtually impossible because the interferences would have to be of such a high energy that they supply the pulse stage with voltage and, in addition, would have to maintain a relatively long input pulse for the pulse stage 7 in order to cause an unintentional switching.

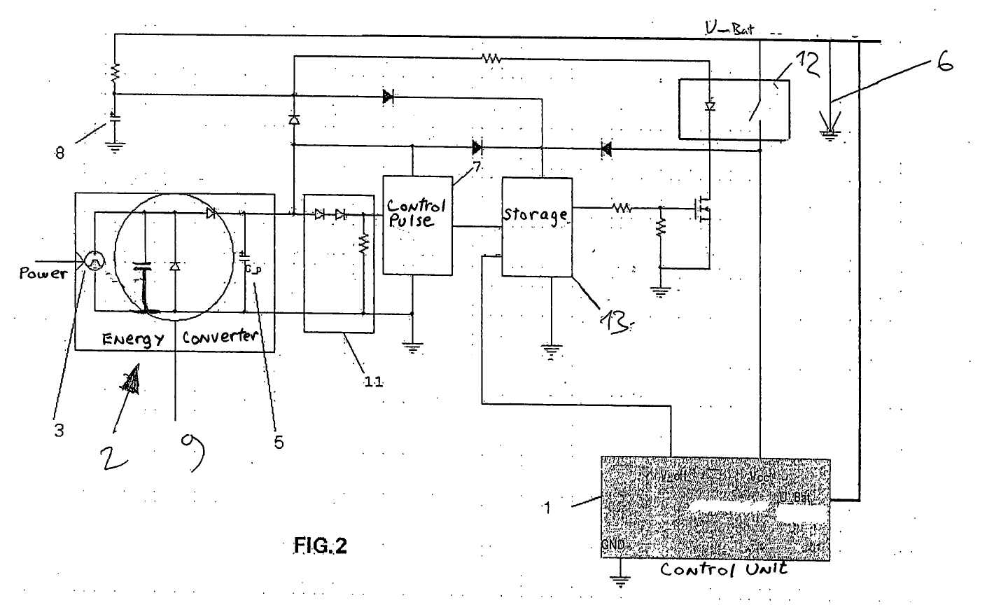

FIG. 2 illustrates another embodiment of the prompting circuit. In contrast to the first embodiment, the locking function is implemented by a storage circuit 13, for example, in the CMOS method. The storage circuit 13 may have two fed-back NAND gates. During the entire time in which the control unit 1 works in the normal operation, the storage circuit 13 has to be supplied with voltage, so that the switch-off signal of the control unit can be processed. The power supply for the storage circuit 13 can, in addition to the supply from the short-term energy accumulator 5, take place either from the auxiliary energy accumulator 8 and/or from the switched-through supply voltage Vcc for the control unit 1. As a result, it is ensured that a switch-off signal V off can be generated by the control unit 1 during the normal operation, in order to isolate it from the battery voltage U Bat. The energy accumulator 5 is not supplied from the auxiliary voltage source 8 or from the switched-through battery voltage Vcc, but, in the normal operation, is charged directly by way of the battery voltage U Bat.

The switch 12 illustrated in FIG. 2 may be an electronic relay or a discrete transistor circuit. After prompting has taken place, the control unit 1 carries out its software-controlled function. This may also include the detection of the access authorization of the operating person. The energy required for detecting the access authorization is in this case supplied by the additionally connected supply voltage Vcc. When the test result is negative, the control unit 1 can be uncoupled from the power supply. Particularly during closing functions for the door of a vehicle, the energy required to check the access authorization can only take place via the energy generated during the prompting operation itself when all voltage regulators are switched off in the sleep mode.

The control unit 1 is supplied with the supply voltage Vcc which is provided by a voltage regulator. In the normal operational state, the voltage regulator provides the optimal operating voltage of the control unit 1. A logic circuit can be provided for checking the access authorization when the control unit 1 is to be switched into the normal operational state by the prompting device 2.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-7. (canceled)

8. A system for prompting a control unit in a vehicle having a power supply circuit for changing the control unit from a normal operational state to a sleep mode, and a prompting device which is operable to switch the power supply through in order to change the control unit into the normal operational state; wherein,
the prompting device is supplied with substantially no current in the sleep mode and has a dischargeable energy accumulator;
when the prompting device is operated, energy of the energy accumulator is used to change the control unit into the normal operational state;
as a result of the energy of the energy accumulator, a switch is operable to connect the control unit to a power supply; and
the energy accumulator can be charged in the normal operational state, or mechanical energy can be converted to electric power when the prompting device is operated.

9. The system according to claim 1, wherein the energy accumulator includes one of a backup capacitor and a foil capacitor.

10. The system according to claim 9, wherein:
an electric switch is arranged between the transport device power supply and the control unit;
in the normal operational state, the switch supplies the control unit with an operating voltage; and
in the sleep mode, the switch blocks, so that the control unit is switched substantially current-free in the sleep mode.

11. The system according to claim 10, wherein the prompting device has a piezogenerator.

12. The system according to claim 11, wherein the piezogenerator is coupled with a mechanical energy accumulator.

13. The system according to claim 12, wherein a rectifier is connected in front of the energy accumulator, which rectifier permits the utilization of both polarities of the alternating voltage generated by the piezogenerator.

14. The system according to claim 12, wherein the auxiliary energy accumulator supplies a supplementary energy which supplements the energy provided by the energy accumulator during the switch-on operation.
